(19) United States
(12) Patent Application Publication
(10) Pub. No.: US 2021/0086846 A1
(43) Pub. Date: Mar. 25, 2021

(54) Adjustable Car Spoiler

(71) Applicant: Ukyo Duong, San Jose, CA (US)

(72) Inventor: Ukyo Duong, San Jose, CA (US)

(21) Appl. No.: 17/030,364

(22) Filed: Sep. 23, 2020

Related U.S. Application Data
(60) Provisional application No. 62/904,438, filed on Sep. 23, 2019.
(60) Provisional application No. 62/990,851, filed on Mar. 17, 2020.

(51) Int. Cl. B62D 37/02; B60R 16/023; B62D 35/00

(52) U.S. Cl. CPC B62D 37/02; B62D 35/00; B60R 16/0231

(57) ABSTRACT

An adjustable car spoiler provides an apparatus to connect an adjustable wing or spoiler system to any car, allowing the user to manually control the wing height and the angle of attack. The apparatus may allow the vehicle on-board computer to control wing position and orientation by interfacing to the ODB II connector of a car (or any other future connector type). Alternatively, the apparatus can allow for tail modification through remote or vocal commands, as well as through manual position manipulation. A series of telescoping connectors and their corresponding actuators enables the desired movement capacity. Different motors may synchronize to enable adjustment of the tilt of the wing during vehicle use. Stabilizing features, such as various beams and mounts, ensure that no undesired motion of the apparatus is possible. This arrangement enables a user to modify relevant positional properties of the wing in order to optimize overall performance.

The current application claims a priority to the U.S. Provisional Patent application Ser. No. 62/904,438 filed on Sep. 23, 2019 and a priority to the U.S. Provisional Patent application Ser. No. 62/990,851 filed on Mar. 17, 2020.

### FIELD OF THE INVENTION

The present invention generally relates to plug-and-play raised car wing system with flexible mounting adapters, controlled via radio frequency remote control, hardwired toggle switch, Bluetooth, WiFi internet, and vehicle traveling speed data from a vehicle available connector, such as ODB II. More specifically, the present invention allows the wing system to be mounted on any vehicle, and both the height of the wing and the angle of attack of the wing can be manually adjusted and/or by the aforementioned methods of controls.

### BACKGROUND OF THE INVENTION

A vehicle with an efficient, aerodynamically-designed raised wing is better equipped to manipulate handling drive and overall performance. The wing or spoiler itself is mainly responsible for this result. When angled steeply, more downward force is applied to the rear wheels, resulting in improved grip. Unfortunately, such downward force also increases drag and fuel consumption. Conversely, angled in the opposite direction, the wing reduces downward force on the back wheels. This has the generally positive effect of reducing fuel consumption, but also the negative effects of increasing instability and diminishing handling and performance. Different vehicles, with different weights and aerodynamic properties, generally benefit from custom orientations of spoilers, due both to the vehicle properties and due to different operational conditions, such as racing or driving on icy surfaces.

Unfortunately, most vehicle manufacturers install wing systems with cost minimization as a priority, thus sacrificing a potentially beneficial adjustable wing for a less expensive static wing. This prevents drivers from being able to optimize their vehicles for different driving situations. What is needed is a system by which a user may adjust the height and angle of a vehicle's spoiler. Further desirable is a system by which the tail may be adjusted remotely, using a variety of different controls that are easily accessible while driving.

The present invention addresses these issues. An objective of the adjustable car spoiler is to provide a means of connecting an adjustable wing system to any car, allowing the user to manually control the wing height and the angle of attack. The present invention may further allow the vehicle on-board computer to control wing position and orientation by interfacing to the ODB II connector of a car (or any other future connector type). A series of telescoping connectors and their corresponding actuators enables the desired movement capacity. Different motors may synchronize to enable adjustment of the tilt of the wing during vehicle use. Stabilizing features, such as various beams and mounts, ensure that no undesired motion of the present invention is possible. This arrangement enables a user to modify relevant positional properties of the wing in order to optimize overall performance.

### BRIEF DESCRIPTION OF THE DRAWINGS

FIG. 1 is a front perspective view of the present invention, with the first linear actuator and the second linear actuator both extended.

FIG. 2 is a front perspective view of the present invention, with the first linear actuator and the second linear actuator both contracted.

FIG. 3 is a perspective view of the first trunk-attachment mechanism of the present invention.

FIG. 4 is a perspective view of the second trunk-attachment mechanism of the present invention.

FIG. 5 is a perspective view of the first fixed-tilt setting of the present invention.

FIG. 6 is a perspective view of the second fixed-tilt setting of the present invention.

FIG. 7 is a block diagram representing the electronic connections of the present invention.

### DETAILED DESCRIPTION OF THE INVENTION

All illustrations of the drawings are for the purpose of describing selected versions of the present invention and are not intended to limit the scope of the present invention.

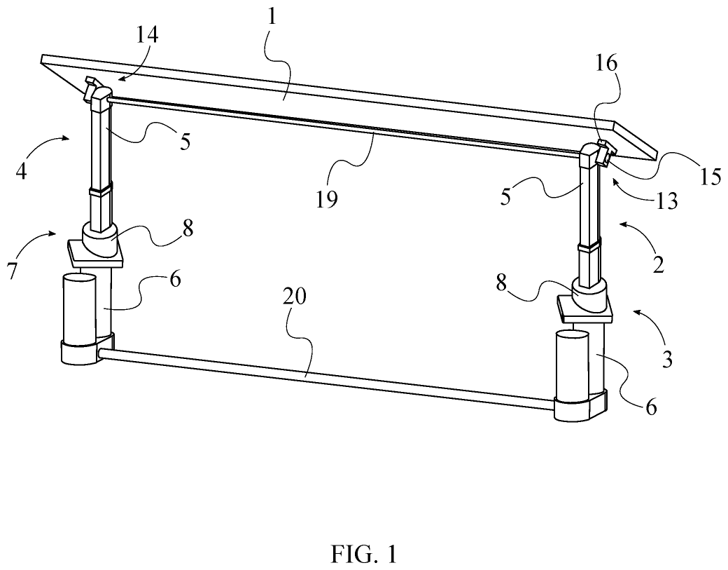

The present invention is an adjustable car spoiler that is used to manipulate the position and orientation of the spoiler of a vehicle. The present invention is also configured to adjust the spoiler, either automatically by connecting to the vehicle's on-board computing systems, or manually through manual control input or physical adjustment. The present invention may comprise a wing 1, a first linear actuator 2, a first trunk-attachment mechanism 3, a second linear actuator 4, a second trunk-attachment mechanism 7, and a microcontroller 12, as seen in FIG. 1. The wing 1 is used as an airfoil to aerodynamically generate the downward or upward force on a moving car. The first linear actuator 2 is a mechanism which enables linear translational motion of appropriately connected objects. The first trunk-attachment mechanism 3 relates to an assembly by which the present invention may mount securely to a trunk. Similar to the first linear actuator 2, the second linear actuator 4 is a mechanism which enables linear translational motion of appropriately connected objects. Similar to the first trunk-attachment mechanism 3, the second trunk-attachment mechanism 7 relates to an assembly by which the present invention may mount securely to a trunk. The microcontroller 12 allows the present invention to receive various electronic inputs from sensors and the like, to apply preprogrammed logic to the input values, and to relay appropriate electronic signals to the appropriate components.

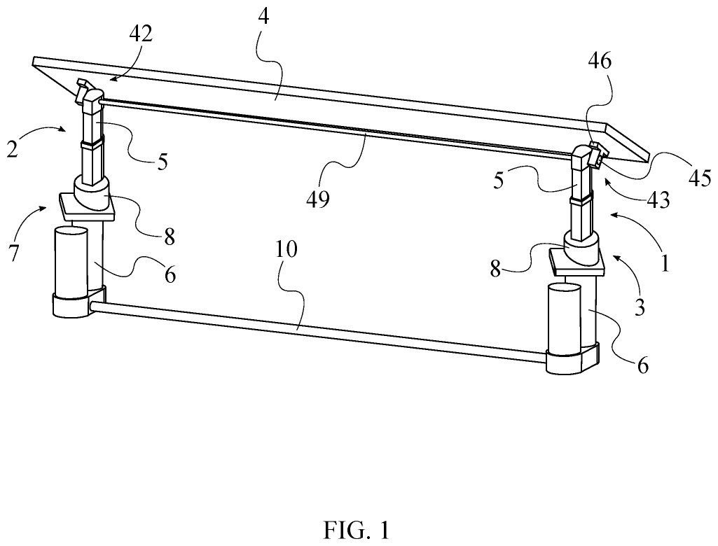

The general configuration of the aforementioned components allows the present invention to efficiently and effectively retrofit an adjustable spoiler to a vehicle's trunk. The first linear actuator 2 and the second linear actuator 4 each comprise a piston 5 and a cylinder 6, as seen in FIG. 2. The piston 5 is the dynamic component of a linear actuator and is used to convey the linear translational force to move an object. The cylinder 6 is the static component of a linear actuator and is used to generate the linear translational force that is conveyed by the piston 5. The first linear actuator 2 and the second linear actuator 4 are positioned opposite to each other across the wing 1. This arrangement enables the first linear actuator 2 and the second linear actuator 4 to evenly support the wing 1 in various orientations relative to the trunk. The piston 5 is operatively coupled to the cylinder 6, wherein the cylinder 6 is used to selectively move the piston 5 back and forth in a linear direction. Thus, the cylinder 6 controls the position and motion of the piston 5 on both the first linear actuator 2 and the second linear actuator 4. The piston 5 of the first linear actuator 2 is mounted onto the wing 1. This arrangement enables the first linear actuator 2 to manipulate the position of the wing 1 with its piston 5. The first trunk-attachment mechanism 3 is laterally mounted to the cylinder 6 of the first linear actuator 2. In this way, the piston 5 of the first linear actuator 2 may actuate between the first trunk-attachment mechanism 3 and the wing 1. Similarly, the piston 5 of the second linear actuator 4 is mounted onto the wing 1. This arrangement enables the second linear actuator 4 to manipulate the position of the wing 1 with its piston 5. The second trunk-attachment mechanism 7 is laterally mounted to the cylinder 6 of the second linear actuator 4. In this way, the piston 5 of the second linear actuator 4 may actuate between the second trunk-attachment mechanism 7 and the wing 1. The microcontroller 12 is electronically connected to the first linear actuator 2 and the second linear actuator 4. This arrangement enables the microcontroller 12 to change the position of the first linear actuator 2 and the second linear actuator 4 in response to various signal inputs.

The present invention further may enable a user to adjust the angle at which the wing 1 interacts with incident wind, thus affecting the resultant pressure upon the rear axle. To this end, the present invention may further comprise a first tilt mechanism 13 and a second tilt mechanism 14, as seen in FIG. 1. The first tilt mechanism 13 and the second tilt mechanism 14 both relate to an adjustable rotation-enabling unit, such as a servo motor or other rotating electronic device. The first tilt mechanism 13 is operatively integrated in between the piston 5 of the first linear actuator 2 and the wing 1, wherein the first tilt mechanism 13 is used to adjust a pitch angle of the wing 1. Likewise, the second tilt mechanism 14 is operatively integrated in between the piston 5 of the second linear actuator 4 and the wing 1, wherein the second tilt mechanism 14 is used to adjust a pitch angle of the wing 1. In this way, the first tilt mechanism 13 and the second tilt mechanism 14 can be used together to adjust the pitch of the wing 1 to a desired angle.

The first tilt mechanism 13 and the second tilt mechanism 14 both benefit from ease of pivoting and also require a mechanism by which to secure in place. To achieve these goals, the first tilt mechanism 13 and the second tilt mechanism 14 may each comprise a peg 15 and a sleeve clamp 16, as seen in FIG. 1. The peg 15 relates to a rigid cylindrical extrusion capable of securing within an appropriate socket or space. The sleeve clamp 16 connotes a retaining fixture which selectively prevents movement of contained components. The peg 15 of the first tilt mechanism 13 is laterally connected to the piston 5 of the first linear actuator 2. This arrangement enables the piston 5 of the first linear actuator 2 to pivot relative to the peg 15 of the first tilt mechanism 13. The wing 1 is laterally connected to the sleeve clamp 16 of the first tilt mechanism 13. This arrangement enables the wing 1 to adjust its tilt based upon the rotation of the sleeve clamp 16 of the first tilt mechanism 13. Similarly, the peg 15 of the second tilt mechanism 14 is laterally connected to the piston 5 of the second linear actuator 4. This arrangement enables the piston 5 of the second linear actuator 4 to pivot relative to the peg 15 of the second tilt mechanism 14. The wing 1 is laterally connected to the sleeve clamp 16 of the second tilt mechanism 14. This arrangement enables the wing 1 to adjust its tilt based upon the rotation of the sleeve clamp 16 of the second tilt mechanism 14. The sleeve clamp 16 is laterally positioned around the peg 15. In this way, the sleeve clamp 16 can secure the peg 15 in place, preventing rotation of the peg 15 of the first tilt mechanism 13 and the peg 15 of the second tilt mechanism 14. The peg 15 is laterally pressed against by the sleeve clamp 16. Thus, the sleeve clamp 16 may be adjusted to allow or prevent modification of the angle of the wing 1.

There may be many other mechanisms which may automate the tilt of the wing 1 relative to the first linear actuator 2 and the second linear actuator 4. To achieve this, the first tilt mechanism 13 and the second tilt mechanism 14 may be a pair of rotary actuators, as seen in FIG. 1. This arrangement enables the first tilt mechanism 13 and the second tilt mechanism 14 to pivot and retain a desired pivoted position. The microcontroller 12 is electronically connected to the first tilt mechanism 13 and the second tilt mechanism 14. Thus, signals from the microcontroller 12 may affect the angular position of the pair of rotary actuators.

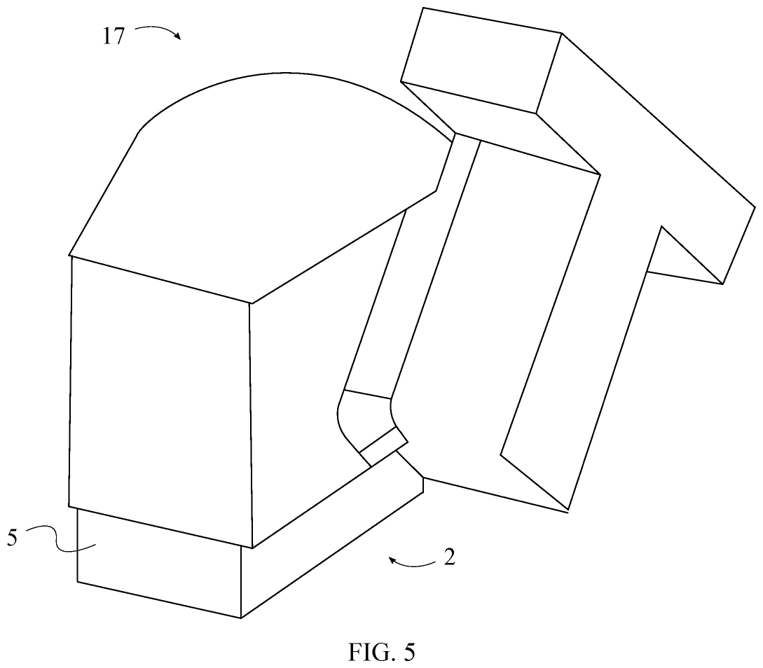

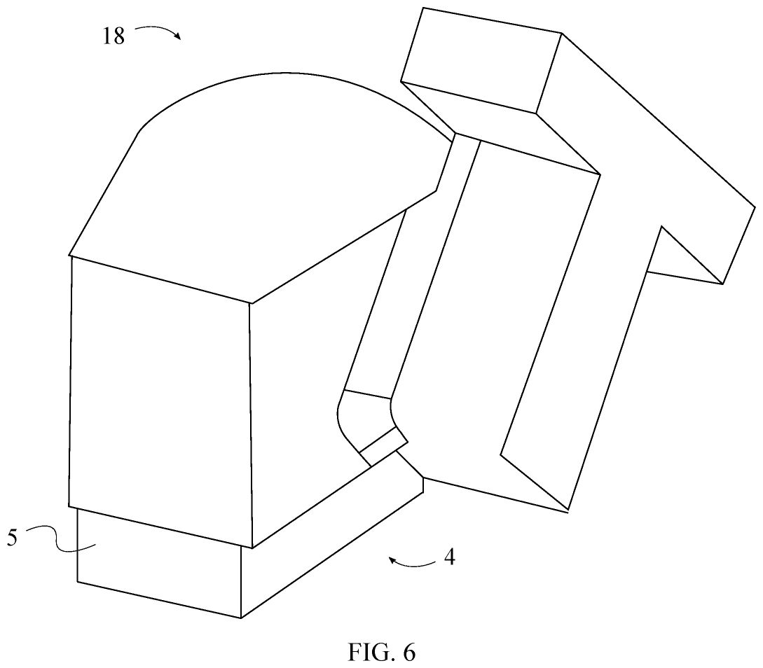

In many applications, it may be desirable to fix the pitch of the wing 1 in place relative to the first linear actuator 2 and the second linear actuator 4. To achieve this, the present invention may further comprise a first fixed-tilt setting 17 and a second fixed-tilt setting 18, as seen in FIGS. 5 and 6. The first fixed-tilt setting 17 relates to a fastener arranged at a predetermined optimal angle. Similarly, the second fixed-tilt setting 18 relates to a fastener arranged at a predetermined optimal angle equal to the angle of the first fixed-tilt setting 17. The piston 5 of the first linear actuator 2 is mounted onto the wing 1 by the first fixed-tilt setting 17. This arrangement ensures that the first linear actuator 2 is oriented at a constant angle relative to the wing 1. Similarly, the piston 5 of the second linear actuator 4 is mounted onto the wing 1 by the second fixed-tilt setting 18. This also ensures that the wing 1 is positioned at a constant angle relative to the second linear actuator 4.

The present invention requires a balancing mechanism by which to prevent wobbling of the first linear actuator 2 relative to the second linear actuator 4. To achieve this, the present invention may further comprise a first stabilizer rod 19, as seen in FIG. 1. The first stabilizer rod 19 relates to a rigid member that restricts movement potential of the present invention. The first stabilizer rod 19 is connected in between the piston 5 of the first linear actuator 2 and the piston 5 of the second linear actuator 4. This arrangement ensures that the piston 5 of the first linear actuator 2 cannot move relative to the piston 5 of the second linear actuator 4. The first stabilizer rod 19 is positioned offset from the first trunk-attachment mechanism 3 and the second trunk-attachment mechanism 7. Thus, the first stabilizer rod 19 prevents the present invention from swaying due to uneven forces being applied to the first linear actuator 2 and the second linear actuator 4 near the wing 1.

The present invention further increases stability by preventing wobbling of the base of the first linear actuator 2 relative to the base of the second linear actuator 4. To achieve this, the present invention may further comprise a second stabilizer rod 20, as seen in FIG. 1. The second stabilizer rod 20 relates to a rigid member that restricts movement potential of the present invention. The second stabilizer rod 20 is connected in between the cylinder 6 of the first linear actuator 2 and the cylinder 6 of the second linear actuator 4. This arrangement ensures that the cylinder 6 of the first linear actuator 2 cannot move relative to the cylinder 6 of the second linear actuator 4. The second stabilizer rod 20 is positioned offset from the first trunk-attachment mechanism 3 and the second trunk-attachment mechanism 7. Thus, the second stabilizer rod 20 prevents the present invention from swaying due to uneven forces being applied to the first linear actuator 2 and the second linear actuator 4 away from the wing 1.

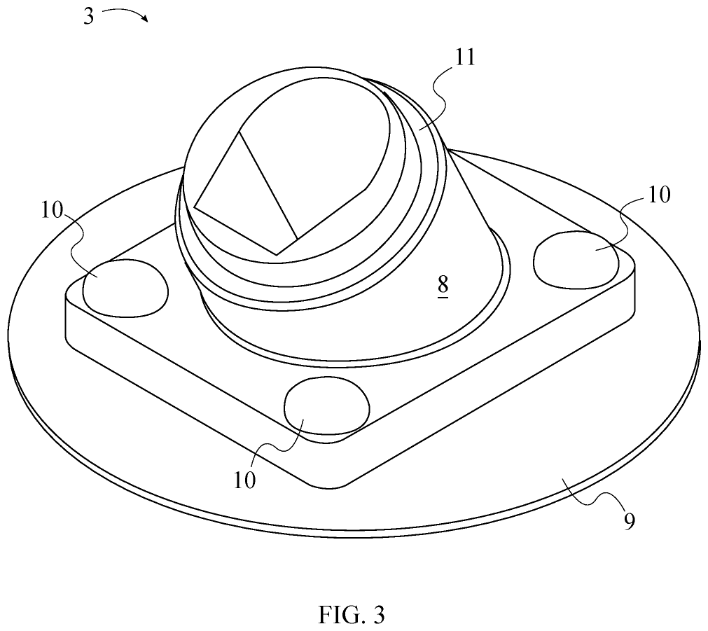

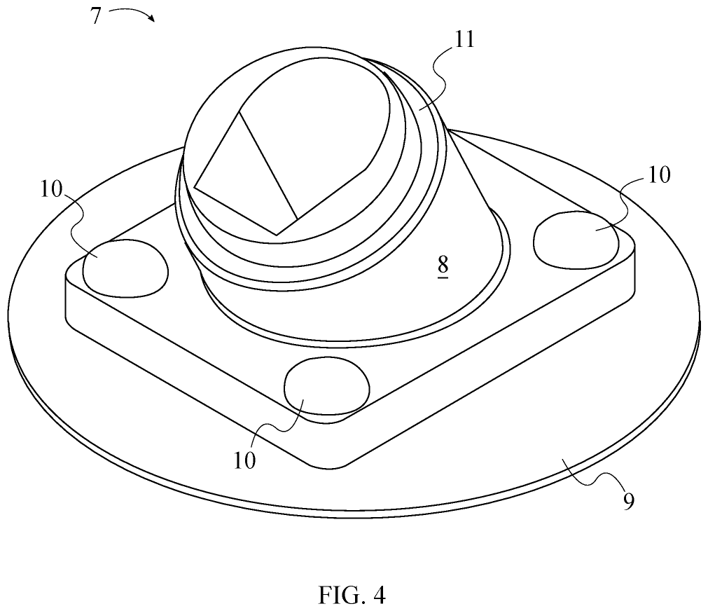

The first trunk-attachment mechanism 3 and the second trunk-attachment mechanism 7 both must be secure in a variety of weather conditions and under varied different stresses during use. To prevent damage due to various conditions, the first trunk-attachment mechanism 3 and the second trunk-attachment mechanism 7 each comprise a structural tubular base 8, a waterproofing gasket 9, and a plurality of fasteners 10, as seen in FIGS. 3 and 4. The structural tubular base 8 relates to a structural member capable of orienting the first linear actuator 2 and the second linear actuator 4. The waterproofing gasket 9 relates to a preferably polymeric hollow disk that prevents damage of the vehicle due to fluids or wear. The plurality of fasteners 10 connotes a set of rigid units capable of securing the structural tubular base 8 in place, preferably against a vehicle's trunk. The cylinder 6 of the first linear actuator 2 is mounted through the structural tubular base 8 and the waterproofing gasket 9 of the first trunk-attachment mechanism 3. This arrangement allows the cylinder 6 of the first linear actuator 2 to maintain its orientation relative to the vehicle's trunk. The cylinder 6 of the second linear actuator 4 is mounted through the structural tubular base 8 and the waterproofing gasket 9 of the second trunk-attachment mechanism 7. This arrangement allows the cylinder 6 of the second linear actuator 4 to maintain its orientation relative to the vehicle's trunk. The waterproofing gasket 9 is pressed against the structural tubular base 8 by the plurality of fasteners 10. In this way, the waterproofing gasket 9 is able to seal the holes through the vehicle's trunk that are used to receive the first linear actuator 2 and the second linear actuator 4.

Two areas of concerns in relation to poor weather are the space in between the first linear actuator 2 and the structural tubular base 8 of the first trunk-attachment mechanism 3 and the space in between the second linear actuator 4 and the structural tubular base 8 of the second trunk-attachment mechanism 7. To this end, the first trunk-attachment mechanism 3 and the second trunk-attachment mechanism 7 each may further comprise a waterproofing seal 11, as seen in FIGS. 3 and 4. The waterproofing seal 11 is used to prevent water from entering those aforementioned spaces. The cylinder 6 of the first linear actuator 2 is hermetically mounted through the structural tubular base 8 of the first trunk-attachment mechanism 3 by the waterproofing seal 11 of the first trunk-attachment mechanism 3. This arrangement ensures that water cannot seep through the structural tubular base 8 of the first trunk-attachment mechanism 3 and into the vehicle's trunk. Similarly, the cylinder 6 of the second linear actuator 4 is hermetically mounted through the structural tubular base 8 of the second trunk-attachment mechanism 7 by the waterproofing seal 11 of the second trunk-attachment mechanism 4. This arrangement ensures that water cannot seep through the structural tubular base 8 of the first trunk-attachment mechanism 3 and into the vehicle's trunk.

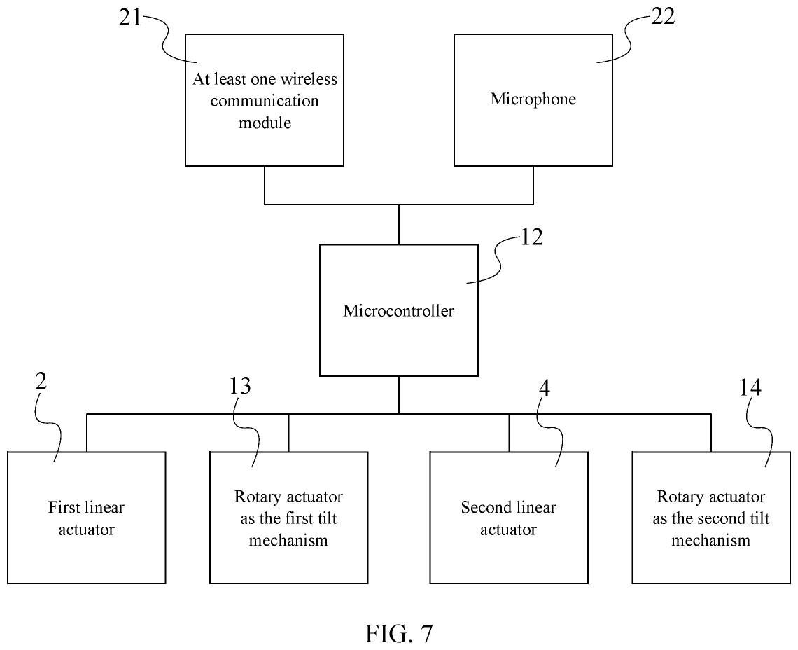

The microcontroller 12 of the present invention may respond to a variety of different input signals that may be generated by the vehicle onboard computer or by the user. To enable the user to communicate with the microcontroller 12, the present invention may further comprise at least one wireless communication module 21, as seen in FIG. 7. The at least one wireless communication module 21 relates to an electronic unit capable of enabling communication to the internet or wireless devices, including both long-range and short-range wireless networks. The microcontroller 12 is electronically connected to the at least one wireless communication module 21. Thus, the microcontroller 12 may receive signals from the user through wireless controls, such as through the use of a personal computing device or the like.

In a further embodiment, it may be desirable for a user to interface with the microcontroller 12 using voice commands. To enable this communication, the present invention may further comprise a microphone 22, as seen in FIG. 7. The microphone 22 relates to an audio sensor capable of collecting audio data generated by the user. The microcontroller 12 is electronically connected to the microphone 22. Thus, the microcontroller 12 may receive and respond to voice signals from the user.

Although the invention has been explained in relation to its preferred embodiment, it is to be understood that many other possible modifications and variations can be made without departing from the spirit and scope of the invention as hereinafter claimed.

What is claimed is:

1. An adjustable car spoiler comprises:
a wing;
a first linear actuator;
a first trunk-attachment mechanism;
a second linear actuator;
a second trunk-attachment mechanism;
a microcontroller;
the first linear actuator and the second linear actuator each comprise a piston and a cylinder;
the first linear actuator and the second linear actuator being positioned opposite to each other across the wing;
the piston being operatively coupled to the cylinder, wherein the cylinder is used to selectively move the piston back and forth in a linear direction;
the piston of the first linear actuator being mounted onto the wing;
the first trunk-attachment mechanism being laterally mounted to the cylinder of the first linear actuator;
the piston of the second linear actuator being mounted onto the wing;
the second trunk-attachment mechanism being laterally mounted to the cylinder of the second linear actuator; and
the microcontroller being electronically connected to the first linear actuator and the second linear actuator.

2. The adjustable car spoiler as claimed in claim 1 comprises:
a first tilt mechanism;
a second tilt mechanism;
the first tilt mechanism being operatively integrated in between the piston of the first linear actuator and the wing, wherein the first tilt mechanism is used to adjust a pitch angle of the wing; and
the second tilt mechanism being operatively integrated in between the piston of the second linear actuator and the wing, wherein the second tilt mechanism is used to adjust the pitch angle of the wing.

3. The adjustable car spoiler as claimed in claim 2 comprises:
the first tilt mechanism and the second tilt mechanism each comprise a peg and a sleeve clamp;
the peg of the first tilt mechanism being laterally connected to the piston of the first linear actuator;
the wing being laterally connected to the sleeve clamp of the first tilt mechanism;
the peg of the second tilt mechanism being laterally connected to the piston of the second linear actuator;
the wing being laterally connected to the sleeve clamp of the second tilt mechanism;
the sleeve clamp being laterally positioned around the peg; and
the peg being laterally pressed against by the sleeve clamp.

4. The adjustable car spoiler as claimed in claim 2 comprises:
the first tilt mechanism and the second tilt mechanism being a pair of rotary actuators; and
the microcontroller being electronically connected to the first tilt mechanism and the second tilt mechanism.

5. The adjustable car spoiler as claimed in claim 1 comprises:
a first fixed-tilt setting;
a second fixed-tilt setting;
the piston of the first linear actuator being mounted onto the wing by the first fixed-tilt setting; and
the piston of the second linear actuator being mounted onto the wing by the second fixed-tilt setting.

6. The adjustable car spoiler as claimed in claim 1 comprises:
a first stabilizer rod;
the first stabilizer rod being connected in between the piston of the first linear actuator and the piston of the second linear actuator; and
the first stabilizer rod being positioned offset from the first trunk-attachment mechanism and the second trunk-attachment mechanism.

7. The adjustable car spoiler as claimed in claim 1 comprises:
a second stabilizer rod;
the second stabilizer rod being connected in between the cylinder of the first linear actuator and the cylinder of the second linear actuator; and
the second stabilizer rod being positioned offset from the first trunk-attachment mechanism and the second trunk-attachment mechanism.

8. The adjustable car spoiler as claimed in claim 1 comprises:
the first trunk-attachment mechanism and the second trunk-attachment mechanism each comprise a structural tubular base, a waterproofing gasket, and a plurality of fasteners;
the cylinder of the first linear actuator being mounted through the structural tubular base and the waterproofing gasket of the first trunk-attachment mechanism;
the cylinder of the second linear actuator being mounted through the structural tubular base and the waterproofing gasket of the second trunk-attachment mechanism; and
the waterproofing gasket being pressed against the structural tubular base by the plurality of fasteners.

9. The adjustable car spoiler as claimed in claim 8 comprises:
the first trunk-attachment mechanism and the second trunk-attachment mechanism each further comprise a waterproofing seal;
the cylinder of the first linear actuator being hermetically mounted through the structural tubular base of the first trunk-attachment mechanism by the waterproofing seal of the first trunk-attachment mechanism; and
the cylinder of the second linear actuator being hermetically mounted through the structural tubular base of the second trunk-attachment mechanism by the waterproofing seal of the second trunk-attachment mechanism.

10. The adjustable car spoiler as claimed in claim 1 comprises:
at least one wireless communication module; and
the microcontroller being electronically connected to the at least one wireless communication module.

11. The adjustable car spoiler as claimed in claim 1 comprises:
a microphone; and
the microcontroller being electronically connected to the microphone.

12. An adjustable car spoiler comprises:
a wing;
a first linear actuator;
a first trunk-attachment mechanism;
a second linear actuator;
a second trunk-attachment mechanism;
a microcontroller;
a first tilt mechanism;
a second tilt mechanism;
the first linear actuator and the second linear actuator each comprise a piston and a cylinder;
the first trunk-attachment mechanism and the second trunk-attachment mechanism each comprise a structural tubular base, a waterproofing gasket, and a plurality of fasteners;
the first linear actuator and the second linear actuator being positioned opposite to each other across the wing;
the piston being operatively coupled to the cylinder, wherein the cylinder is used to selectively move the piston back and forth in a linear direction;
the piston of the first linear actuator being mounted onto the wing;
the first trunk-attachment mechanism being laterally mounted to the cylinder of the first linear actuator;
the piston of the second linear actuator being mounted onto the wing;
the second trunk-attachment mechanism being laterally mounted to the cylinder of the second linear actuator;
the microcontroller being electronically connected to the first linear actuator and the second linear actuator;
the first tilt mechanism being operatively integrated in between the piston of the first linear actuator and the wing, wherein the first tilt mechanism is used to adjust a pitch angle of the wing;
the second tilt mechanism being operatively integrated in between the piston of the second linear actuator and the wing, wherein the second tilt mechanism is used to adjust the pitch angle of the wing;
the cylinder of the first linear actuator being mounted through the structural tubular base and the waterproofing gasket of the first trunk-attachment mechanism;
the cylinder of the second linear actuator being mounted through the structural tubular base and the waterproofing gasket of the second trunk-attachment mechanism; and
the waterproofing gasket being pressed against the structural tubular base by the plurality of fasteners.

13. The adjustable car spoiler as claimed in claim 12 comprises:
the first tilt mechanism and the second tilt mechanism each comprise a peg and a sleeve clamp;
the peg of the first tilt mechanism being laterally connected to the piston of the first linear actuator;
the wing being laterally connected to the sleeve clamp of the first tilt mechanism;
the peg of the second tilt mechanism being laterally connected to the piston of the second linear actuator;
the wing being laterally connected to the sleeve clamp of the second tilt mechanism;
the sleeve clamp being laterally positioned around the peg; and
the peg being laterally pressed against by the sleeve clamp.

14. The adjustable car spoiler as claimed in claim 13 comprises:
the first tilt mechanism and the second tilt mechanism being a pair of rotary actuators; and
the microcontroller being electronically connected to the first tilt mechanism and the second tilt mechanism.

15. The adjustable car spoiler as claimed in claim 12 comprises:
a first fixed-tilt setting;
a second fixed-tilt setting;
the piston of the first linear actuator being mounted onto the wing by the first fixed-tilt setting; and
the piston of the second linear actuator being mounted onto the wing by the second fixed-tilt setting.

16. The adjustable car spoiler as claimed in claim 12 comprises:
a first stabilizer rod;
the first stabilizer rod being connected in between the piston of the first linear actuator and the piston of the second linear actuator; and
the first stabilizer rod being positioned offset from the first trunk-attachment mechanism and the second trunk-attachment mechanism.

17. The adjustable car spoiler as claimed in claim 12 comprises:
a second stabilizer rod;
the second stabilizer rod being connected in between the cylinder of the first linear actuator and the cylinder of the second linear actuator; and
the second stabilizer rod being positioned offset from the first trunk-attachment mechanism and the second trunk-attachment mechanism.

18. The adjustable car spoiler as claimed in claim 12 comprises:
the first trunk-attachment mechanism and the second trunk-attachment mechanism each further comprise a waterproofing seal;
the cylinder of the first linear actuator being hermetically mounted through the structural tubular base of the first trunk-attachment mechanism by the waterproofing seal of the first trunk-attachment mechanism; and
the cylinder of the second linear actuator being hermetically mounted through the structural tubular base of the second trunk-attachment mechanism by the waterproofing seal of the second trunk-attachment mechanism.

19. The adjustable car spoiler as claimed in claim 12 comprises:
at least one wireless communication module; and
the microcontroller being electronically connected to the at least one wireless communication module.

20. The adjustable car spoiler as claimed in claim 12 comprises:
a microphone; and
the microcontroller being electronically connected to the microphone.
